(19) United States
(12) Patent Application Publication
(10) Pub. No.: US 2026/0167905 A1
(43) Pub. Date: Jun. 18, 2026

(54) LAUNDRY COMPOSITION

(71) Applicant: GIVAUDAN SA, VERNIER (CH)

(72) Inventor: Mathieu ZONGO, VERNIER (CH)

(21) Appl. No.: 19/126,149

(22) PCT Filed: Nov. 13, 2023
(86) PCT No.: PCT/EP2023/081638

§ 371 Date: Apr. 30, 2025

(30) Foreign Application Priority Data
Nov. 15, 2022 (SG) 10202260101U

(51) Int. Cl. C11D 17/06; C11D 3/22; C11D 3/50; C11D 11/00

(52) U.S. Cl. CPC C11D 17/06; C11D 3/225; C11D 3/502; C11D 11/0082; C11D 2111/12

(57) ABSTRACT

The present invention provides a granulated composition for powder detergent, the composition comprising a perfume composition that is entrapped in a water-soluble matrix and a solid carrier, wherein the median particle size by volume (Dv(50)) of the granulated composition is between about 90 μm to about 190 μm.

The present invention relates to a granulated composition for powder detergent, to a process for making such a composition and to a use of such a composition for obtaining a consumer product.

### BACKGROUND OF THE INVENTION

It is known to incorporate encapsulated functional materials in consumer products, such as household care, personal care and fabric care products. Functional materials include for example perfumes, cosmetic actives, and biologically active ingredients, such as biocides and drugs.

Spray-drying is a well-known technique for the encapsulation of perfumes. Such spray-dried perfume compositions are commonly prepared from an emulsion of the perfume to be encapsulated, which is sprayed into a drying chamber. In this process, biopolymers with surface active properties are generally used as emulsifiers which, upon spray-drying, form a water-soluble matrix in which the perfume becomes entrapped.

By way of example, WO 1999/055819 A1 relates to modified starch encapsulated high impact perfume accords.

Such spray-dried compositions provide a powder perfume format which is simple to manufacture and shows good odor benefits. Furthermore, since nowadays consumers are more aware of environmental and resource protection, those encapsulates have become even more attractive, as they are often based on bio-sourced materials. The spray-dried compositions thus have a low ecological footprint and allow for encapsulation of perfumes with high efficiency. They also exhibit beneficial release properties.

From the safety point of view, the commercial spray-dried compositions are evaluated according to their minimum ignition energy (MIE). The MIE value is used to assess the likelihood of ignition during processing and handling. The lower the MIE, the higher the risk of explosion as a very small energy input can trigger a dust cloud explosion. MIE is determined according to ASTM E 2019, Standard Test Method for Minimum Ignition Energy of a Dust Cloud in Air (ASTM, 2007b). MIE for ignition of dust clouds vary with dust type, particle size, and other factors. As expected, in commercial settings it is desirable to handle spray-dried compositions with MIE values that are not an ignition concern.

Commercial detergent compositions contain perfume mixed with or sprayed onto the compositions as most consumers nowadays expect that the detergent products are scented.

In many parts of the world handwashing is the predominant means of laundering fabrics. When handwashing soiled fabrics the user often comes in contact with the wash solution and is in close proximity to the detergent product used therein. Therefore, it is desirable and commercially beneficial to add perfume materials to such products which can provide the consumer with a fragrance experience at every step of the washing process. Various techniques have been developed to provide a timed release of perfume from compositions so that they will remain olfactively pleasing for a longer length of time.

However, there is still a need to provide granulated compositions which are suitable for being incorporated into powder detergents, which are capable of providing increased olfactive performance at different stages of the washing process and which are not an ignition concern.

### SUMMARY OF THE INVENTION

In a first aspect, the present invention relates to a granulated composition for powder detergent, the composition comprising
a) a perfume composition that is entrapped in a water-soluble matrix; and
b) a solid carrier,
   wherein the median particle size by volume (Dv(50)) of the granulated composition is between about 90 μm to about 190 μm, optionally between about 95 μm to about 150 μm, optionally between about 100 μm to about 125 μm.

In another aspect, a method of making a granulated composition as described herein is provided.

The use of a granulated composition as described herein, wherein the granulated composition is incorporated into a powder detergent is also provided.

In one aspect, a powder detergent comprising a granulated composition as described herein is provided.

### Definitions

In context of the present invention, a “biodegradable ingredient” is an ingredient which meets the pass criteria for “inherently biodegradable” and/or “readily biodegradable” in at least one OECD biodegradation study. In order to avoid any ambiguity, this means that if an ingredient passes one test but fails one or more other ones, the pass result overrules the other test results. Dv50 or Dv(50) represents the maximum particle diameter below which 50% of the sample volume exists—also known as the median particle size by volume. It is also known as “volume weighted distributions” or the Malvern volume weighted particle size distribution and is commonly measured using light scattering techniques. The results of the Malvern measurements can be expressed as Dv50 (D—for diameter, v—for volume, 50—for percentage of sample below this particle size e.g. 50%).

Water activity is defined as the ratio of the water vapor pressure of a product containing a certain amount of water compared to pure water at the same temperature.

### DETAILED DESCRIPTION

Preferred and/or optional features of the invention will now be set out. Any aspect of the invention may be combined with any other aspect of the invention unless the context demands otherwise. Any of the preferred or optional features of any aspect may be combined, singly or in combination, with any aspect of the invention, as well as with any other preferred or optional features, unless the context demands otherwise.

The applicant has surprisingly and unexpectedly found that a granulated composition for powder detergent, the composition comprising
a) a perfume composition that is entrapped in a water-soluble matrix; and
b) a solid carrier,
   wherein the median particle size by volume (Dv(50)) of the granulated composition is between about 90 μm to about 190 μm is capable of providing superior olfactive performance compared to granulated compositions with Dv(50) values smaller than about 90 μm or Dv(50) values larger than about 190 μm. More advantageously, such a granulated composition is not an ignition concern.

Entrapment of perfume ingredients in a water-soluble matrix makes it not only possible to protect them from the environmental influences, thereby conserving the exact composition of a perfume, but also to release the perfume in a more controlled manner. The perfume ingredients can be released from the matrix by a dual mode of activation: either under moisture (e.g. upon dissolution into water) and/or mechanical activation (e.g. friction).

For a given ratio between the perfume composition and the entrapping polymer, when the particle size of the entrapping polymer decreases, the total effective surface area of the matrix is increased, therefore the dissolution rate of the polymer is relatively high. As such, reduction of the particle size leads to reduction of the thickness of the diffusion layer surrounding the perfume oil droplet in the matrix particles, resulting in an increase of the concentration gradient.

This results in the perfume being released shortly after contact with the water. On the other hand, larger particle sizes lead to an increase of the thickness of the diffusion layer surrounding the oil droplets, resulting in reduction of the concentration gradient and the dissolution rate.

Therefore, in order to achieve the desired olfactive performance at different stages of the washing process when incorporated into a detergent composition, an optimum range for the particle size of a granulated composition needs to be determined.

The inventors have found that a granulated composition as defined herein wherein the median particle size by volume of the granulated composition is between about 90 μm to about 190 μm, optionally between about 95 μm to about 150 μm, optionally between about 100 μm to about 125 μm is capable of providing the optimum perfume release profile when employed in a powder detergent.

### Water-Soluble Matrix

The water-soluble matrix can comprise at least one material selected from the group consisting of starch, in particular water-soluble modified starch, maltodextrin, mannitol, chitosan, gum Arabic, alginate, cellulose, pectins, gelatin, polyvinyl alcohol and mixtures thereof. The resulting perfume formulations are facile and cost-effective in manufacture, for instance by spray-drying. They are prepared of naturally-based materials, which are non-toxic and biodegradable. Such formats therefore have an increased consumer-appeal.

When the starch is a water-soluble modified starch, such starch can be made from raw starch or pre-gelatinized starch. It can be derived from tubers, legumes, cereals and grains, for example corn starch, wheat starch, rice starch, waxy corn starch, oat starch, cassava starch, waxy barley starch, waxy rice starch, sweet rice starch, amioca starch, potato starch, tapioca starch and mixtures thereof.

The water-soluble modified starch can be selected from the group consisting of bleached starch, hydroxypropyl starch, hydroxypropyl distarch phosphate, dydroxypropyl distarch glycerol, acetylated distarch phosphate, starch acetate esterified with acetic anhydride, starch acetate esterified with vinyl acetate, acetylated distarch adipate, acetylated distarch glycerol, starch sodium octenyl succinate and mixtures thereof.

Water-soluble modified starches have emulsifying and emulsion-stabilizing capacity. They have the ability to entrap perfume droplets in the form of oil-in-water emulsions due to the hydrophobic character of the starch modifying agent. The modified starches as described herein above bring numerous advantages including high emulsification and entrapping performance, low viscosity, even at high solids content, and excellent oxidation resistance to ensure good perfume preservation and stabilization of sensitive ingredients.

When the water-soluble matrix comprises a water-soluble modified starch, it can additionally comprise a material selected from the group consisting of maltodextrin, mannitol and mixtures thereof. Maltodextrin and mannitol both increase the glass transition temperature of the matrix. Furthermore, maltodextrin is a film forming agent.

Maltodextrins are characterized by their dextrin equivalent (DE). The higher the DE, the lower the molecular weight of the maltodextrin. In the context of the present invention, maltodextrin having different DE may be combined to provide optimized encapsulation properties. Without wishing to be bound by theory, it is believed that mixtures of low and high DE maltodextrins improve the packing of the water-soluble matrix.

Further to the materials stated herein above, the water-soluble matrix can additionally comprise a hemicellulose. In the context of the present invention, the expression “hemicellulose” is to be understood as a polysaccharide selected from the group consisting of glucans, in particular xyloglucans, mannans, in particular glucomannans, and xylans, in particular arabinoxylans and glucuronoxylans.

It has been found that addition of a hemicellulose to a water-soluble matrix, in particular a starch matrix, leads to a modification of the matrix, improving its perfume release properties under moisture and mechanical (e.g. friction) activation.

The hemicellulose is preferably a xyloglucan, in particular a xyloglucan obtainable from tamarind seeds. Xyloglucans are the most abundant hemicellulose in the primary walls of non-graminaceous plants, often comprising 20 wt.-% of the dry mass of the wall. A xyloglucan has a backbone composed of 1,4-linked β-D-glucose residues. Up to 75% of the backbone residues are substituted at C6 with mono-, di-, or trisaccharide sidechains. Preferably, the hemicellulose is a xyloglucan obtainable from tamarind seeds, in particular obtained from tamarind seeds, also known as “tamarind kernelpowder” or “tamarind gum”. In tamarind gum, the side chains consist of one or two α-D-xylopyranosyl units, optionally capped with β-D-galactopyranosyl, β-L-arabinofuranosyl or β-D-xylopyranosyl.

In preferred embodiments of the present invention, the water-soluble matrix is in particulate form.

### Perfume Composition

The perfume composition comprises at least one perfume ingredient. The at least one perfume ingredient can belong to different classes of organic compounds, as varied as alcohols, ketones, esters, ethers, acetates, terpene hydrocarbons, nitrogenous or sulphurous heterocyclic compounds and essential oils, which can be of natural or synthetic origin. Many of these perfume ingredients are listed in reference texts, such as S. Arctander, Perfume and Flavor Chemicals, 1994, Montclair, New Jersey, USA.

Preferably, the at least one perfume ingredient has a boiling point determined at the normal standard pressure of 1013.25 hPa of 275° C. or lower and an odor detection threshold of less than or equal to 50 parts per billion (ppb).

In a particular embodiment of the present invention, the least one perfume ingredient is selected from the group consisting of ACETOPHENONE EXTRA (1-phenylethanone); ADOXAL (2,6,10-trimethylundec-9-enal); AGRUMEX (2-(tert-butyl)cyclohexyl acetate); ALCOHOL C 6 HEXYLIC (hexan-1-ol); ALDEHYDE C 10 DECYLIC (decanal); ALDEHYDE C 11 MOA (2-methyldecanal); ALDEHYDE C 11 UNDECYLENIC (undec-10-enal); ALDEHYDE C 110 UNDECYLIC (undecanal); ALDEHYDE C 12 LAURIC (dodecanal); ALDEHYDE C 12 MNA PURE (2-methylundecanal); ALDEHYDE C 6 HEXYLIC FOOD GRADE (hexan-1-al); ALDEHYDE C 8 OCTYLIC FOOD GRADE (octanal); ALDEHYDE C 9 ISONONYLIC (3,5,5-trimethylhexanal); ALDEHYDE C 9 NONYLIC FOOD GRADE (nonanal); ALDEHYDE ISO C 11 ((E)-undec-9-enal); ALLYL AMYL GLYCOLATE (prop-2-enyl 2-(3-methylbutoxy)acetate); ALLYL CAPROATE (prop-2-enyl hexanoate); ALLYL CYCLOHEXYL PROPIONATE (prop-2-enyl 3-cyclohexylpropanoate); ALLYL OENANTHATE (prop-2-enyl heptanoate); AMBERKETAL (3,8,8,11a-tetramethyldodecahydro-1H-3,5a-epoxynaphtho[2,1-c]oxepine); AMBRETTOLIDE ((Z)-oxacycloheptadec-10-en-2-one); AMBROFIX ((3aR,5aS,9aS,9bR)-3a,6,6,9a-tetramethyl-2,4,5,5a,7,8,9,9b-octahydro-1H-benzo[e][1]benzofuran); AMYL BUTYRATE (pentyl butanoate); AMYL CINNAMIC ALDEHYDE ((Z)-2-benzylideneheptanal); AMYL SALICYLATE (pentyl 2-hydroxybenzoate); ANETHOLE ((E)-1-methoxy-4-(prop-1-en-1-yl)benzene); ANISYL ACETATE (4-methoxybenzyl acetate); APHERMATE (1-(3,3-dimethylcyclohexyl)ethyl formate); AUBEPINE PARA CRESOL (4-methoxybenzaldehyde); AURANTIOL ((E)-methyl 2-((7-hydroxy-3,7-dimethyloctylidene)amino)benzoate); BENZALDEHYDE (benzaldehyde); BENZYL ACETATE (benzyl acetate); BENZYL ACETONE (4-phenylbutan-2-one); BENZYL ALCOHOL (phenylmethanol); BENZYL BENZOATE (benzyl benzoate); BENZYL CINNAMATE (benzyl 3-phenylprop-2-enoate); BENZYL SALICYLATE (benzyl 2-hydroxybenzoate); BICYCLO NONALACTONE (octahydro-2H-chromen-2-one); BORNEOL CRYSTALS ((1S,2S,4S)-1,7,7-trimethylbicyclo[2.2.1]heptan-2-ol); BORNYL ACETATE ((2S,4S)-1,7,7-trimethylbicyclo[2.2.1]heptan-2-yl acetate); BOURGEONAL (3-(4-(tert-butyl)phenyl)propanal); BUTYL ACETATE (butyl acetate); BUTYL CYCLOHEXYL ACETATE PARA (4-(tert-butyl)cyclohexyl acetate); CAMPHOR ((1S,4S)-1,7,7-trimethylbicyclo[2.2.1]heptan-2-one); CARVONE LAEVO ((5R)-2-methyl-5-prop-1-en-2-ylcyclohex-2-en-1-one); CEDRYL METHYL ETHER ((1R,6S,8aS)-6-methoxy-1,4,4,6-tetramethyloctahydro-1H-5,8a-methanoazulene); CETONE V ((E)-1-(2,6,6-trimethylcyclohex-2-en-1-yl)hepta-1,6-dien-3-one); CINNAMIC ALCOHOL SYNTHETIC ((E)-3-phenylprop-2-en-1-ol); CINNAMIC ALDEHYDE ((2E)-3-phenylprop-2-enal); CINNAMYL ACETATE ((E)-3-phenylprop-2-en-1-yl acetate); CIS-3-HEXENOL ((Z)-hex-3-en-1-ol); CIS JASMONE ((Z)-3-methyl-2-(pent-2-en-1-yl)cyclopent-2-enone); CITRAL ((E)-3,7-dimethylocta-2,6-dienal); CITRONELLAL (3,7-dimethyloct-6-enal); CITRONELLOL (3,7-dimethyloct-6-en-1-ol); CITRONELLYL ACETATE (3,7-dimethyloct-6-en-1-yl acetate); CITRONELLYL FORMATE (3,7-dimethyloct-6-en-1-yl formate); CITRONELLYL NITRILE (3,7-dimethyloct-6-enenitrile); CLONAL (dodecanenitrile); CORANOL (4-cyclohexyl-2-methylbutan-2-ol); CORYLONE DRIED (2-hydroxy-3-methylcyclopent-2-enone); COSMONE ((Z)-3-methylcyclotetradec-5-enone); COUMARIN PURE CRYSTALS (2H-chromen-2-one); CRESYL METHYL ETHER PARA (1-methoxy-4-methylbenzene); CUMIN NITRILE (4-isopropylbenzonitrile); CYCLAMEN ALDEHYDE EXTRA (3-(4-isopropylphenyl)-2-methylpropanal); DAMASCENONE ((E)-1-(2,6,6-trimethylcyclohexa-1,3-dien-1-yl)but-2-en-1-one); DAMASCONE ALPHA ((E)-1-(2,6,6-trimethylcyclohex-2-en-1-yl)but-2-en-1-one); DECALACTONE GAMMA (5-hexyloxolan-2-one); DECENAL-4-TRANS ((E)-dec-4-enal); DIHYDRO ANETHOLE (1-methoxy-4-propylbenzene); DIHYDRO MYRCENOL (2,6-dimethyloct-7-en-2-ol); DIMETHYL BENZYL CARBINYL ACETATE (2-methyl-1-phenylpropan-2-yl acetate); DIMETHYL BENZYL CARBINYL BUTYRATE (2-methyl-1-phenylpropan-2-yl butanoate); DIMETOL (2,6-dimethylheptan-2-ol); DIPHENYL OXIDE (oxydibenzene); DODECENAL ((E)-dodec-2-enal); EBANOL ((E)-3-methyl-5-(2,2,3-trimethylcyclopent-3-en-1-yl)pent-4-en-2-ol); ESTERLY (ethyl cyclohexyl carboxylate); ETHYL ACETATE (ethyl acetate); ETHYL ACETOACETATE (ethyl 3-oxobutanoate); ETHYL CINNAMATE (ethyl 3-phenylprop-2-enoate); ETHYL HEXANOATE (ethyl hexanoate); ETHYL LINALOOL ((E)-3,7-dimethylnona-1,6-dien-3-ol); ETHYL MALTOL (2-ethyl-3-hydroxy-4H-pyran-4-one); ETHYL METHYL-2-BUTYRATE (ethyl 2-methylbutanoate); ETHYL OENANTHATE (ethyl heptanoate); ETHYL VANILLIN (3-ethoxy-4-hydroxybenzaldehyde); ETHYLENE BRASSYLATE (1,4-dioxacycloheptadecane-5,17-dione); EUCALYPTOL NATURAL ((1s,4s)-1,3,3-trimethyl-2-oxabicyclo[2.2.2]octane); EUGENOL (4-allyl-2-methoxyphenol); EVERNYL (methyl 2,4-dihydroxy-3,6-dimethylbenzoate); FENCHYL ALCOHOL ((1S,2R,4R)-1,3,3-trimethylbicyclo[2.2.1]heptan-2-ol); FENNALDEHYDE (3-(4-methoxyphenyl)-2-methylpropanal); FLORHYDRAL (3-(3-isopropylphenyl)butanal); FLOROSA HC (tetrahydro-4-methyl-2-(2-methylpropyl)-2H-pyran-4-ol); FRESKOMENTHE (2-(sec-butyl)cyclohexanone); FRUTONILE (2-methyldecanenitrile); GALBANONE PURE (1-(5,5-dimethylcyclohex-1-en-1-yl)pent-4-en-1-one); GERANIOL ((E)-3,7-dimethylocta-2,6-dien-1-ol); GERANYL ACETATE ((E)-3,7-dimethylocta-2,6-dien-1-yl acetate); GERANYL ACETONE ((E)-6,10-dimethylundeca-5,9-dien-2-one); HABANOLIDE ((E)-oxacyclohexadec-12-en-2-one); HEDIONE (methyl 3-oxo-2-pentylcyclopentaneacetate); HELIOTROPINE CRYSTALS (benzo[d][1,3]dioxole-5-carbaldehyde); HEXENAL-2-TRANS ((E)-hex-2-enal); HEXENOL-3-CIS ((Z)-hex-3-en-1-ol); HEXENYL-3-CIS ACETATE ((Z)-hex-3-en-1-yl acetate); HEXENYL-3-CIS ISOBUTYRATE ((Z)-hex-3-en-1-yl 2-methylpropanoate); HEXENYL-3-CIS SALICYLATE ((Z)-hex-3-en-1-yl 2-hydroxybenzoate); HEXYL ACETATE (hexyl acetate); HEXYL CINNAMIC ALDEHYDE ((E)-2-benzylideneoctanal); HEXYL ISOBUTYRATE (hexyl 2-methylpropanoate); HEXYL SALICYLATE (hexyl 2-hydroxybenzoate); HYDROXYCITRONELLAL (7-hydroxy-3,7-dimethyloctanal); INDOLE PURE (1H-indole); IONONE BETA ((E)-4-(2,6,6-trimethylcyclohex-1-en-1-yl)but-3-en-2-one); IRISONE ALPHA ((E)-4-(2,6,6-trimethylcyclohex-2-en-1-yl)but-3-en-2-one); ISOAMYL ACETATE EXTRA (3-methylbutyl acetate); ISOEUGENOL ((E)-2-methoxy-4-(prop-1-en-1-yl)phenol); ISOMENTHONE DL (2-isopropyl-5-methylcyclohexanone); ISOPROPYL METHYL-2-BUTYRATE (isopropyl 2-methylbutanoate); ISORALDEINE ((E)-3-methyl-4-(2,6,6-trimethylcyclohex-2-en-1-yl)but-3-en-2-one); JASMONE CIS ((Z)-3-methyl-2-(pent-2-en-1-yl)cyclopent-2-enone); JASMONYL (3-butyl-5-methyltetrahydro-2H-pyran-4-yl acetate); JASMOPYRANE FORTE (3-pentyltetrahydro-2H-pyran-4-yl acetate); LIFFAROME ((Z)-hex-3-en-1-yl methyl carbonate); LILIAL (3-(4-(tert-butyl)phenyl)-2-methylpropanal); LIMONENE, LIMONENE, or LAEVO, LIMONENE DEXTRO (1-methyl-4-prop-1-en-2-yl-cyclohexene); LINALOOL OXIDE (2-(5-methyl-5-vinyltetrahydrofuran-2-yl)propan-2-ol); LINALOOL (3,7-dimethylocta-1,6-dien-3-ol); LINALYL ACETATE (3,7-dimethylocta-1,6-dien-3-yl acetate); MAHONIAL ((4E)-9-hydroxy-5,9-dimethyl-4-decenal); MALTOL (3-hydroxy-2-methyl-4H-pyran-4-one); MANZANATE (ethyl 2-methylpentanoate); MAYOL ((4-isopropylcyclohexyl)methanol); MEFROSOL (3-methyl-5-phenylpentan-1-ol); MELONAL (2,6-dimethylhept-5-enal); MENTHOL, MENTHOL LAEVO, or MENTHOL RACEMIC (2-isopropyl-5-methylcyclohexanol); MENTHONE, ISOMENTHONE, MENTHONE LAEVO, or MENTHONE RACEMIC (2-isopropyl-5-methylcyclohexanone); METHYL ANTHRANILATE EXTRA (methyl 2-aminobenzoate); METHYL BENZOATE (methyl benzoate); METHYL CINNAMATE (methyl 3-phenylprop-2-enoate); METHYL DIANTILIS (2-ethoxy-4-(methoxymethyl)phenol); METHYL DIHYDRO ISOJASMONATE (methyl 2-hexyl-3-oxocyclopentane-1-carboxylate); METHYL HEPTENONE (6-methylhept-5-en-2-one); METHYL LAITONE (8-methyl-1-oxaspiro[4.5]decan-2-one); METHYL OCTYNE CARBONATE (methyl non-2-ynoate); METHYL SALICYLATE (methyl 2-hydroxybenzoate); MUSCENONE ((Z)-3-methylcyclopentadec-5-enone); MYRALDENE (4-(4-methylpent-3-en-1-yl)cyclohex-3-enecarbaldehyde); MYRCENE (7-methyl-3-methyleneocta-1,6-diene); MYSTIKAL (2-methylundecanoic acid); NECTARYL (2-(2-(4-methylcyclohex-3-en-1-yl)propyl)cyclopentanone); NEOFOLIONE ((E)-methyl non-2-enoate); NEROLEX ((2Z)-3,7-dimethylocta-2,6-dien-1-ol); NEROLIDOL ((E)-3,7,11-trimethyldodeca-1,6,10-trien-3-ol); NEROLINE CRYSTALS (2-ethoxynaphthalene); NERYL ACETATE HC ((Z)-3,7-dimethylocta-2,6-dien-1-yl acetate); NIRVANOLIDE ((E)-13-methyloxacyclopentadec-10-en-2-one); NONADIENAL ((2E,6Z)-nona-2,6-dienal); NONADIENOL-2,6 ((2Z,6E)-2,6-nonadien-1-ol); NONALACTONE GAMMA (5-pentyloxolan-2-one); NONENAL-6-CIS ((Z)-non-6-enal); NONENOL-6-CIS ((Z)-non-6-en-1-ol); NOPYL ACETATE (2-(6,6-dimethylbicyclo[3.1.1]hept-2-en-2-yl)ethyl acetate); NYMPHEAL (3-(4-(2-methylpropyl)-2-methylphenyl)propanal); OCTANONE-2 (octan-2-one); ORANGER CRYSTALS (1-(2-naphtalenyl)-ethanone); PANDANOL ((2-methoxyethyl)benzene); PEACH PURE (5-heptyldihydrofuran-2(3H)-one); PELARGOL (3,7-dimethyloctan-1-ol); PHARAONE (2-cyclohexylhepta-1,6-dien-3-one); PHENOXY ETHYL ISOBUTYRATE (2-(phenoxy)ethyl 2-methylpropanoate); PHENYL ACETALDEHYDE (2-phenyl-ethanal); PHENYL ETHYL ACETATE (2-phenylethyl acetate); PHENYL ETHYL ALCOHOL (2-phenylethanol); PHENYL ETHYL ISOBUTYRATE (2-phenylethyl 2-methylpropanoate); PHENYL ETHYL PHENYL ACETATE (2-phenylethyl 2-phenylacetate); PHENYL PROPYL ALCOHOL (3-phenylpropan-1-ol); PINENE BETA (6,6-dimethyl-2-methylenebicyclo[3.1.1]heptane); PINOACETALDEHYDE (3-(6,6-dimethylbicyclo[3.1.1]hept-2-en-2-yl)propanal); POMAROSE ((2E,5E)-5,6,7-trimethylocta-2,5-dien-4-one); PRECYCLEMONE B (1-methyl-4-(4-methylpent-3-en-1-yl)cyclohex-3-enecarbaldehyde); PRENYL ACETATE (3-methylbut-2-en-1-yl acetate); RASPBERRY KETONE (4-(4-hydroxyphenyl)butan-2-one); ROSE OXIDE (4-methyl-2-(2-methylprop-1-en-1-yl)tetrahydro-2H-pyran); ROSYRANE SUPER (4-methyl-2-phenyl-3,6-dihydro-2H-pyran); SANDALORE EXTRA (3-methyl-5-(2,2,3-trimethylcyclopent-3-en-1-yl)pentan-2-ol); SCENTAURUS CLEAN (ethyl (Z)-2-acetyl-4-methyltridec-2-enoate); SCENTAURUS JUICY (4-(dodecylthio)-4-methylpentan-2-one); SILVANONE SUPRA (cyclopentadecanone, hexadecanolide); STYRALLYL ACETATE (1-phenylethyl acetate); SUPER MUGUET ((E)-6-ethyl-3-methyloct-6-en-1-ol); SYLKOLIDE ((E)-2-((3,5-dimethylhex-3-en-2-yl)oxy)-2-methylpropyl cyclopropanecarboxylate); TERPINENE GAMMA (1-methyl-4-propan-2-ylcyclohexa-1,4-diene); TERPINEOL ALPHA (2-(4-methyl-1-cyclohex-3-enyl)propan-2-ol); TERPINEOL PURE (2-(4-methylcyclohex-3-en-1-yl)propan-2-ol); TERPINOLENE (1-methyl-4-(propan-2-ylidene)cyclohex-1-ene); TERPINYL ACETATE (2-(4-methyl-1-cyclohex-3-enyl)propan-2-yl acetate); TETRAHYDRO LINALOOL (3,7-dimethyloctan-3-ol); THIBETOLIDE (oxacyclohexadecan-2-one); THYMOL (2-isopropyl-5-methylphenol); TOSCANOL (1-(cyclopropylmethyl)-4-methoxybenzene); TRIDECENE-2-NITRILE ((E)-tridec-2-enenitrile); TRIFERNAL (3-phenylbutanal); TROPIONAL (3-(benzo[d][1,3]dioxol-5-yl)-2-methylpropanal); METHYL NONYL KETONE (undecan-2-one); UNDECATRIENE ((3E,5Z)-undeca-1,3,5-triene); UNDECAVERTOL ((E)-4-methyldec-3-en-5-ol); VANILLIN (4-hydroxy-3-methoxybenzaldehyde); VELVIONE ((Z)-cyclohexadec-5-enone); VIOLET NITRILE ((2E,6Z)-nona-2,6-dienenitrile); and YARA YARA (2-methoxynaphtalene).

In one embodiment, the perfume composition comprises at least one, preferably at least two, more preferably at least four, even more preferably at least eight, even still more preferably at least sixteen, biodegradable ingredient(s).

The perfume compositions entrapped in a water-soluble matrix of the present invention typically have a proportion of perfume composition of up to about 60 wt.-%, relative to the total weight of the perfume composition entrapped in a water-soluble matrix, meaning that a significant portion of the mass of the perfume composition entrapped in the water-soluble matrix consists of the perfume composition. As a consequence of this, the overall ecological footprint of the granulated composition can be significantly improved—independent of the matrix material—by using biodegradable ingredient(s) for the perfume composition. Biodegradation is the key process for removal of perfume ingredients in the environment.

In a particular embodiment of the present invention, the biodegradable ingredient(s) is/are selected from the group consisting of ACETOPHENONE EXTRA (1-phenylethanone); ADOXAL (2,6,10-trimethylundec-9-enal); AGRUMEX (2-(tert-butyl)cyclohexyl acetate); ALCOHOL C 6 HEXYLIC (hexan-1-ol); ALDEHYDE C 10 DECYLIC (decanal); ALDEHYDE C 11 MOA (2-methyldecanal); ALDEHYDE C 11 UNDECYLENIC (undec-10-enal); ALDEHYDE C 110 UNDECYLIC (undecanal); ALDEHYDE C 12 LAURIC (dodecanal); ALDEHYDE C 12 MNA PURE (2-methylundecanal); ALDEHYDE C 6 HEXYLIC FOOD GRADE (hexan-1-al); ALDEHYDE C 8 OCTYLIC FOOD GRADE (octanal); ALDEHYDE C 9 ISONONYLIC (3,5,5-trimethylhexanal); ALDEHYDE C 9 NONYLIC FOOD GRADE (nonanal); ALDEHYDE ISO C 11 ((E)-undec-9-enal); ALLYL AMYL GLYCOLATE (prop-2-enyl 2-(3-methylbutoxy)acetate); ALLYL CAPROATE (prop-2-enyl hexanoate); ALLYL CYCLOHEXYL PROPIONATE (prop-2-enyl 3-cyclohexylpropanoate); ALLYL OENANTHATE (prop-2-enyl heptanoate); AMBERKETAL (3,8,8,11a-tetramethyldodecahydro-1H-3,5a-epoxynaphtho[2,1-c]oxepine); AMBRETTOLIDE ((Z)-oxacycloheptadec-10-en-2-one); AMBROFIX ((3aR,5aS,9aS,9bR)-3a,6,6,9a-tetramethyl-2,4,5,5a,7,8,9,9b-octahydro-1H-benzo[e][1]benzofuran); AMYL BUTYRATE (pentyl butanoate); AMYL CINNAMIC ALDEHYDE ((Z)-2-benzylideneheptanal); AMYL SALICYLATE (pentyl 2-hydroxybenzoate); ANETHOLE ((E)-1-methoxy-4-(prop-1-en-1-yl)benzene); ANISYL ACETATE (4-methoxybenzyl acetate); APHERMATE (1-(3,3-dimethylcyclohexyl)ethyl formate); AUBEPINE PARA CRESOL (4-methoxybenzaldehyde); AURANTIOL ((E)-methyl 2-((7-hydroxy-3,7-dimethyloctylidene)amino)benzoate); BENZALDEHYDE (benzaldehyde); BENZYL ACETATE (benzyl acetate); BENZYL ACETONE (4-phenylbutan-2-one); BENZYL ALCOHOL (phenylmethanol); BENZYL BENZOATE (benzyl benzoate); BENZYL CINNAMATE (benzyl 3-phenylprop-2-enoate); BENZYL SALICYLATE (benzyl 2-hydroxybenzoate); BICYCLO NONALACTONE (octahydro-2H-chromen-2-one); BORNEOL CRYSTALS ((1S,2S,4S)-1,7,7-trimethylbicyclo[2.2.1]heptan-2-ol); BORNYL ACETATE ((2S,4S)-1,7,7-trimethylbicyclo[2.2.1]heptan-2-yl acetate); BOURGEONAL (3-(4-(tert-butyl)phenyl)propanal); BUTYL ACETATE (butyl acetate); BUTYL CYCLOHEXYL ACETATE PARA (4-(tert-butyl)cyclohexyl acetate); CAMPHOR ((1S,4S)-1,7,7-trimethylbicyclo[2.2.1]heptan-2-one); CARVONE LAEVO ((5R)-2-methyl-5-prop-1-en-2-ylcyclohex-2-en-1-one); CEDRYL METHYL ETHER ((1R,6S,8aS)-6-methoxy-1,4,4,6-tetramethyloctahydro-1H-5,8a-methanoazulene); CETONE V ((E)-1-(2,6,6-trimethylcyclohex-2-en-1-yl)hepta-1,6-dien-3-one); CINNAMIC ALCOHOL SYNTHETIC ((E)-3-phenylprop-2-en-1-ol); CINNAMIC ALDEHYDE ((2E)-3-phenylprop-2-enal); CINNAMYL ACETATE ((E)-3-phenylprop-2-en-1-yl acetate); CIS-3-HEXENOL ((Z)-hex-3-en-1-ol); CIS JASMONE ((Z)-3-methyl-2-(pent-2-en-1-yl)cyclopent-2-enone); CITRAL ((E)-3,7-dimethylocta-2,6-dienal); CITRONELLAL (3,7-dimethyloct-6-enal); CITRONELLOL (3,7-dimethyloct-6-en-1-ol); CITRONELLYL ACETATE (3,7-dimethyloct-6-en-1-yl acetate); CITRONELLYL FORMATE (3,7-dimethyloct-6-en-1-yl formate); CITRONELLYL NITRILE (3,7-dimethyloct-6-enenitrile); CLONAL (dodecanenitrile); CORANOL (4-cyclohexyl-2-methylbutan-2-ol); CORYLONE DRIED (2-hydroxy-3-methylcyclopent-2-enone); COSMONE ((Z)-3-methylcyclotetradec-5-enone); COUMARIN PURE CRYSTALS (2H-chromen-2-one); CRESYL METHYL ETHER PARA (1-methoxy-4-methylbenzene); CUMIN NITRILE (4-isopropylbenzonitrile); CYCLAMEN ALDEHYDE EXTRA (3-(4-isopropylphenyl)-2-methylpropanal); DAMASCENONE ((E)-1-(2,6,6-trimethylcyclohexa-1,3-dien-1-yl)but-2-en-1-one); DAMASCONE ALPHA ((E)-1-(2,6,6-trimethylcyclohex-2-en-1-yl)but-2-en-1-one); DECALACTONE GAMMA (5-hexyloxolan-2-one); DECENAL-4-TRANS ((E)-dec-4-enal); DIHYDRO ANETHOLE (1-methoxy-4-propylbenzene); DIHYDRO MYRCENOL (2,6-dimethyloct-7-en-2-ol); DIMETHYL BENZYL CARBINYL ACETATE (2-methyl-1-phenylpropan-2-yl acetate); DIMETHYL BENZYL CARBINYL BUTYRATE (2-methyl-1-phenylpropan-2-yl butanoate); DIMETOL (2,6-dimethylheptan-2-ol); DIPHENYL OXIDE (oxydibenzene); DODECENAL ((E)-dodec-2-enal); EBANOL ((E)-3-methyl-5-(2,2,3-trimethylcyclopent-3-en-1-yl)pent-4-en-2-ol); ESTERLY (ethyl cyclohexyl carboxylate); ETHYL ACETATE (ethyl acetate); ETHYL ACETOACETATE (ethyl 3-oxobutanoate); ETHYL CINNAMATE (ethyl 3-phenylprop-2-enoate); ETHYL HEXANOATE (ethyl hexanoate); ETHYL LINALOOL ((E)-3,7-dimethylnona-1,6-dien-3-ol); ETHYL MALTOL (2-ethyl-3-hydroxy-4H-pyran-4-one); ETHYL METHYL-2-BUTYRATE (ethyl 2-methylbutanoate); ETHYL OENANTHATE (ethyl heptanoate); ETHYL VANILLIN (3-ethoxy-4-hydroxybenzaldehyde); ETHYLENE BRASSYLATE (1,4-dioxacycloheptadecane-5,17-dione); EUCALYPTOL NATURAL ((1s,4s)-1,3,3-trimethyl-2-oxabicyclo[2.2.2]octane); EUGENOL (4-allyl-2-methoxyphenol); EVERNYL (methyl 2,4-dihydroxy-3,6-dimethylbenzoate); FENCHYL ALCOHOL ((1S,2R,4R)-1,3,3-trimethylbicyclo[2.2.1]heptan-2-ol); FENNALDEHYDE (3-(4-methoxyphenyl)-2-methylpropanal); FLORHYDRAL (3-(3-isopropylphenyl)butanal); FLOROSA HC (tetrahydro-4-methyl-2-(2-methylpropyl)-2H-pyran-4-ol); FRESKOMENTHE (2-(sec-butyl)cyclohexanone); FRUTONILE (2-methyldecanenitrile); GALBANONE PURE (1-(5,5-dimethylcyclohex-1-en-1-yl)pent-4-en-1-one); GERANIOL ((E)-3,7-dimethylocta-2,6-dien-1-ol); GERANYL ACETATE ((E)-3,7-dimethylocta-2,6-dien-1-yl acetate); GERANYL ACETONE ((E)-6,10-dimethylundeca-5,9-dien-2-one); HABANOLIDE ((E)-oxacyclohexadec-12-en-2-one); HEDIONE (methyl 3-oxo-2-pentylcyclopentaneacetate); HELIOTROPINE CRYSTALS (benzo[d][1,3]dioxole-5-carbaldehyde); HEXENAL-2-TRANS ((E)-hex-2-enal); HEXENOL-3-CIS ((Z)-hex-3-en-1-ol); HEXENYL-3-CIS ACETATE ((Z)-hex-3-en-1-yl acetate); HEXENYL-3-CIS ISOBUTYRATE ((Z)-hex-3-en-1-yl 2-methylpropanoate); HEXENYL-3-CIS SALICYLATE ((Z)-hex-3-en-1-yl 2-hydroxybenzoate); HEXYL ACETATE (hexyl acetate); HEXYL CINNAMIC ALDEHYDE ((E)-2-benzylideneoctanal); HEXYL ISOBUTYRATE (hexyl 2-methylpropanoate); HEXYL SALICYLATE (hexyl 2-hydroxybenzoate); HYDROXYCITRONELLAL (7-hydroxy-3,7-dimethyloctanal); INDOLE PURE (1H-indole); IONONE BETA ((E)-4-(2,6,6-trimethylcyclohex-1-en-1-yl)but-3-en-2-one); IRISONE ALPHA ((E)-4-(2,6,6-trimethylcyclohex-2-en-1-yl)but-3-en-2-one); ISOAMYL ACETATE EXTRA (3-methylbutyl acetate); ISOEUGENOL ((E)-2-methoxy-4-(prop-1-en-1-yl)phenol); ISOMENTHONE DL (2-isopropyl-5-methylcyclohexanone); ISOPROPYL METHYL-2-BUTYRATE (isopropyl 2-methylbutanoate); ISORALDEINE ((E)-3-methyl-4-(2,6,6-trimethylcyclohex-2-en-1-yl)but-3-en-2-one); JASMONE CIS ((Z)-3-methyl-2-(pent-2-en-1-yl)cyclopent-2-enone); JASMONYL (3-butyl-5-methyltetrahydro-2H-pyran-4-yl acetate); JASMOPYRANE FORTE (3-pentyltetrahydro-2H-pyran-4-yl acetate); LIFFAROME ((Z)-hex-3-en-1-yl methyl carbonate); LILIAL (3-(4-(tert-butyl)phenyl)-2-methylpropanal); LIMONENE, LIMONENE, or LAEVO, LIMONENE DEXTRO (1-methyl-4-prop-1-en-2-yl-cyclohexene); LINALOOL OXIDE (2-(5-methyl-5-vinyltetrahydrofuran-2-yl)propan-2-ol); LINALOOL (3,7-dimethylocta-1,6-dien-3-ol); LINALYL ACETATE (3,7-dimethylocta-1,6-dien-3-yl acetate); MAHONIAL ((4E)-9-hydroxy-5,9-dimethyl-4-decenal); MALTOL (3-hydroxy-2-methyl-4H-pyran-4-one); MANZANATE (ethyl 2-methylpentanoate); MAYOL ((4-isopropylcyclohexyl)methanol); MEFROSOL (3-methyl-5-phenylpentan-1-ol); MELONAL (2,6-dimethylhept-5-enal); MENTHOL, MENTHOL LAEVO, or MENTHOL RACEMIC (2-isopropyl-5-methylcyclohexanol); MENTHONE, ISOMENTHONE, MENTHONE LAEVO, or MENTHONE RACEMIC (2-isopropyl-5-methylcyclohexanone); METHYL ANTHRANILATE EXTRA (methyl 2-aminobenzoate); METHYL BENZOATE (methyl benzoate); METHYL CINNAMATE (methyl 3-phenylprop-2-enoate); METHYL DIANTILIS (2-ethoxy-4-(methoxymethyl)phenol); METHYL DIHYDRO ISOJASMONATE (methyl 2-hexyl-3-oxocyclopentane-1-carboxylate); METHYL HEPTENONE (6-methylhept-5-en-2-one); METHYL LAITONE (8-methyl-1-oxaspiro[4.5]decan-2-one); METHYL OCTYNE CARBONATE (methyl non-2-ynoate); METHYL SALICYLATE (methyl 2-hydroxybenzoate); MUSCENONE ((Z)-3-methylcyclopentadec-5-enone); MYRALDENE (4-(4-methylpent-3-en-1-yl)cyclohex-3-enecarbaldehyde); MYRCENE (7-methyl-3-methyleneocta-1,6-diene); MYSTIKAL (2-methylundecanoic acid); NECTARYL (2-(2-(4-methylcyclohex-3-en-1-yl)propyl)cyclopentanone); NEOFOLIONE ((E)-methyl non-2-enoate); NEROLEX ((2Z)-3,7-dimethylocta-2,6-dien-1-ol); NEROLIDOL ((E)-3,7,11-trimethyldodeca-1,6,10-trien-3-ol); NEROLINE CRYSTALS (2-ethoxynaphthalene); NERYL ACETATE HC ((Z)-3,7-dimethylocta-2,6-dien-1-yl acetate); NIRVANOLIDE ((E)-13-methyloxacyclopentadec-10-en-2-one); NONADIENAL ((2E,6Z)-nona-2,6-dienal); NONADIENOL-2,6 ((2Z,6E)-2,6-nonadien-1-ol); NONALACTONE GAMMA (5-pentyloxolan-2-one); NONENAL-6-CIS ((Z)-non-6-enal); NONENOL-6-CIS ((Z)-non-6-en-1-ol); NOPYL ACETATE (2-(6,6-dimethylbicyclo[3.1.1]hept-2-en-2-yl)ethyl acetate); NYMPHEAL (3-(4-(2-methylpropyl)-2-methylphenyl)propanal); OCTANONE-2 (octan-2-one); ORANGER CRYSTALS (1-(2-naphtalenyl)-ethanone); PANDANOL ((2-methoxyethyl)benzene); PEACH PURE (5-heptyldihydrofuran-2(3H)-one); PELARGOL (3,7-dimethyloctan-1-ol); PHARAONE (2-cyclohexylhepta-1,6-dien-3-one); PHENOXY ETHYL ISOBUTYRATE (2-(phenoxy)ethyl 2-methylpropanoate); PHENYL ACETALDEHYDE (2-phenyl-ethanal); PHENYL ETHYL ACETATE (2-phenylethyl acetate); PHENYL ETHYL ALCOHOL (2-phenylethanol); PHENYL ETHYL ISOBUTYRATE (2-phenylethyl 2-methylpropanoate); PHENYL ETHYL PHENYL ACETATE (2-phenylethyl 2-phenylacetate); PHENYL PROPYL ALCOHOL (3-phenylpropan-1-ol); PINENE BETA (6,6-dimethyl-2-methylenebicyclo[3.1.1]heptane); PINOACETALDEHYDE (3-(6,6-dimethylbicyclo[3.1.1]hept-2-en-2-yl)propanal); POMAROSE ((2E,5E)-5,6,7-trimethylocta-2,5-dien-4-one); PRECYCLEMONE B (1-methyl-4-(4-methylpent-3-en-1-yl)cyclohex-3-enecarbaldehyde); PRENYL ACETATE (3-methylbut-2-en-1-yl acetate); RASPBERRY KETONE (4-(4-hydroxyphenyl)butan-2-one); ROSE OXIDE (4-methyl-2-(2-methylprop-1-en-1-yl)tetrahydro-2H-pyran); ROSYRANE SUPER (4-methyl-2-phenyl-3,6-dihydro-2H-pyran); SANDALORE EXTRA (3-methyl-5-(2,2,3-trimethylcyclopent-3-en-1-yl)pentan-2-ol); SCENTAURUS CLEAN (ethyl (Z)-2-acetyl-4-methyltridec-2-enoate); SCENTAURUS JUICY (4-(dodecylthio)-4-methylpentan-2-one); SILVANONE SUPRA (cyclopentadecanone, hexadecanolide); STYRALLYL ACETATE (1-phenylethyl acetate); SUPER MUGUET ((E)-6-ethyl-3-methyloct-6-en-1-ol); SYLKOLIDE ((E)-2-((3,5-dimethylhex-3-en-2-yl)oxy)-2-methylpropyl cyclopropanecarboxylate); TERPINENE GAMMA (1-methyl-4-propan-2-ylcyclohexa-1,4-diene); TERPINEOL ALPHA (2-(4-methyl-1-cyclohex-3-enyl)propan-2-ol); TERPINEOL PURE (2-(4-methylcyclohex-3-en-1-yl)propan-2-ol); TERPINOLENE (1-methyl-4-(propan-2-ylidene)cyclohex-1-ene); TERPINYL ACETATE (2-(4-methyl-1-cyclohex-3-enyl)propan-2-yl acetate); TETRAHYDRO LINALOOL (3,7-dimethyloctan-3-ol); THIBETOLIDE (oxacyclohexadecan-2-one); THYMOL (2-isopropyl-5-methylphenol); TOSCANOL (1-(cyclopropylmethyl)-4-methoxybenzene); TRIDECENE-2-NITRILE ((E)-tridec-2-enenitrile); TRIFERNAL (3-phenylbutanal); TROPIONAL (3-(benzo[d][1,3]dioxol-5-yl)-2-methylpropanal); METHYL NONYL KETONE (undecan-2-one); UNDECATRIENE ((3E,5Z)-undeca-1,3,5-triene); UNDECAVERTOL ((E)-4-methyldec-3-en-5-ol); VANILLIN (4-hydroxy-3-methoxybenzaldehyde); VELVIONE ((Z)-cyclohexadec-5-enone); VIOLET NITRILE ((2E,6Z)-nona-2,6-dienenitrile); and YARA YARA (2-methoxynaphtalene).

The above-mentioned ingredients have all been identified as not only fulfilling at least one of the biodegradability criteria, but also as being suitable for encapsulation with respect to their physical and chemical properties, such as lipophilicity and molecular size. They therefore provide a useful selection of perfume ingredients for readily and reliably providing more sustainable fragrance encapsulates.

In a preferred embodiment, the amount of the perfume composition, i.e. the amount of the least one perfume ingredient entrapped in the water-soluble matrix, is between about 35 wt.-% to about 60 wt.-%, preferably between about 45 wt.-% to about 55 wt.-%, preferably about 50 wt.-% relative to the total weight of the perfume composition that is entrapped in a water-soluble matrix.

### Core-Shell Microcapsules

In context of the present invention, the perfume composition can be partially encapsulated in core-shell microcapsules comprising a core and a shell surrounding the core.

Such compositions allow for fragrance release either through activation by mechanical action or by moisture, for instance when employed as perfume delivery means in consumer products that require, for delivering optimal perfumery benefits, core-shell microcapsules to adhere to a substrate on which they are applied, for instance laundry detergents.

The composition of perfume ingredients that is encapsulated in the core-shell microcapsules and the composition of perfume ingredients that is not encapsulated in the core-shell microcapsules can be the same or different. This results in a modulated release of the same or of different odor impressions, depending on whether the encapsulate is exposed to moisture or mechanical stresses. In particular, a sequential release of the perfume ingredients may be envisioned.

In context of the present invention, the shell of the core-shell of the microcapsules can be made of a biodegradable material or a non-biodegradable material. In particular, the shell of the core-shell microcapsules can comprise a polymer selected from the group consisting of a melamine-formaldehyde polymer, a urea-formaldehyde polymer, a polyurea, a polyurethane, a polyamide, a polyacrylate, a polycarbonate, and mixtures thereof.

### Thermosetting Resins

Core-shell microcapsules with a shell of a melamine-formaldehyde polymer have proven to be particularly suitable for fragrance encapsulation. They are described in the prior art, for instance in WO 2008/098387 A1, WO 2016/207180 A1 and WO 2017/001672 A1.

Also core-shell microcapsules with a shell of a polyurea or polyurethane polymer have been successfully used for perfume encapsulation. They have the advantage to address consumer concerns with regard to residual formaldehyde in the composition. Such capsules are also described in the prior art, for instance in WO 2019/174978 A1.

Core-shell microcapsules with a shell of a polyacrylate, i.e. one or more monoethylenically unsaturated and/or polyethylenically unsaturated monomer(s) in polymerized form, have also been successfully used for perfume encapsulation. Such capsules are described in the prior art, for instance in WO 2013/111912 A1 or WO 2014/032920 A1.

### Polymeric Stabiliser

In one embodiment, the shell may comprise a polymeric stabilizer that is formed by combination of a polymeric surfactant with at least one aminosilane. The polymeric surfactant comprises a polysaccharide comprising carboxylic acid groups. The aminosilane is as defined hereinbelow. The shell may further comprise a polysaccharide, preferably a polysaccharide comprising beta (1→4) linked monosaccharide units, even more preferably a cellulose derivative, in particular selected form the group consisting of hydroxyethyl cellulose, hydroxypropylmethyl cellulose, cellulose acetate, carboxymethyl cellulose, and combinations thereof, preferably hydroxyethyl cellulose. Such capsules are described in the prior art, for instance in WO 2020/233887A1.

### Hydrated Polymer Phase and Polymeric Stabilizer

In one embodiment, the shell may comprise a hydrated polymer phase and a polymeric stabilizer at an interface between the shell and the core.

In such an arrangement, the polymeric stabilizer provides an impervious encapsulating material, whereas the hydrated polymer phase provides the desired deposition and adherence to the substrate. Furthermore, without being bound by any theory, it is surmised that the hydrated polymer phase also provides an optimal point of attack for microbial degradation.

The polymeric stabilizer may be selected from a broad range of film-forming materials and resins. Preferably, the polymeric stabilizer is highly cross-linked, in order to decrease significantly the diffusion of the encapsulated benefit agent through the shell. Preferably the imperviousness of the shell is sufficiently high to significantly prevent the leakage of the benefit agent in extractive base, such as consumer products comprising surfactants.

In one embodiment of the present invention, the polymeric stabilizer is a thermosetting resin.

Thermosetting resins are typically obtained by reacting polyfunctional monomers, such as amines, isocyanates, alcohols or phenols, chlorocarboxylic acids, (meth)acrylates, epoxides, silanes and aldehydes.

In one embodiment of the present invention, the polymeric stabilizer is formed by reaction of an aminosilane with a polyfunctional isocyanate. Such a polymeric stabilizer has the advantage of being highly crosslinked and susceptible of providing surface anchoring groups that can be used to immobilize additional materials to complete shell formation. These additional materials may comprise additional encapsulating materials, coatings and, as described in more details hereinafter, simple and complex coacervate, and hydrogels.

The aminosilane employed in the formation of the polymeric stabilizer can be selected from a compound of Formula (I).

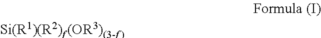

wherein R¹ is a linear or branched alkyl or alkenyl residue comprising an amine functional group; R² is each independently a linear or branched alkyl group with 1 to 4 carbon atoms; R³ is each independently a H or a linear or branched alkyl group with 1 to 4 carbon atoms; and f is 0, 1 or 2.

The silane groups may undergo polycondensation reactions with one another to form a silica network at the oil/water interface that additionally stabilizes this interface.

In one embodiment, R² and R³ are each independently methyl or ethyl.

In one embodiment, f is 0 or 1.

In one embodiment, R¹ is a C₁-C₁₂ linear or branched alkyl or alkenyl residue comprising an amine functional group. Optionally, R¹ is a C₁-C₄ linear or branched alkyl or alkenyl residue comprising an amine functional group.

In one embodiment, the amine functional group is a primary, a secondary or a tertiary amine.

In one embodiment, the at least one aminosilane is a bipodal aminosilane. By “bipodal aminosilane” it is meant a molecule comprising at least one amino group and two residues, each of these residues bearing at least one alkoxysilane moiety. Bipodal aminosilanes are particularly advantageous for forming stable oil-water interfaces, compared to conventional aminosilanes. Without wishing to be bound by theory, it is believed that this beneficial role is due to the particular, bi-directional arrangement of the silane moieties in the molecule of a bipodal aminosilane, which allows formation of a more tightly linked silica network at the oil-water interface.

In one embodiment, the bipodal aminosilane is a compound of Formula (II).

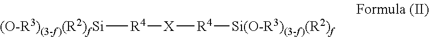

wherein X is —NR⁵—, —NR⁵—CH₂—NR⁵—, —NR⁵—CH₂—CH₂—NR⁵—, —NR⁵—CO—NR⁵—, or

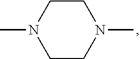

R² is each independently a linear or branched alkyl group with 1 to 4 carbon atoms;
R³ is each independently H or a linear or branched alkyl group with 1 to 4 carbon atoms;
R⁴ is each independently a linear or branched alkylene group with 1 to 6 carbon atoms;
R⁵ is each independently H, CH₃ or C₂H₅; and
f is each independently 0, 1 or 2.

In one embodiment, R² is CH₃ or C₂H.

In one embodiment, R³ is CH₃ or C₂H₅

In one embodiment, R⁴ is —CH₂—, —CH₂—CH₂— or —CH₂—CH₂—CH₂—.

In one embodiment, R⁵ is H or CH₃.

In one embodiment, f is 0 or 1.

Examples of suitable bipodal aminosilanes include, but are not limited to, bis(3-(triethoxysilyl)propyl)amine, N,N′-bis(3-(trimethoxysilyl)propyl)urea, bis(3-(methyldiethoxysilyl) propyl)amine, N,N′-bis(3-(trimethoxysilyl)propyl)ethane-1,2-diamine, bis(3-(methyldimethoxysilyl)propyl)-N-methylamine, N,N′-bis(3-(triethoxysilyl) propyl)piperazine, and combinations thereof.

In one embodiment, the bipodal aminosilane is bis(3-(triethoxysilyl)propyl)amine, which has the advantage of releasing ethanol instead of more toxic and less desirable methanol during the polycondensation of the ethoxysilane groups.

The bipodal aminosilane can be a secondary aminosilane. Using a secondary bipodal aminosilane instead of a primary aminosilane decreases the reactivity of the polymeric stabilizer with respect to electrophilic species, in particular aldehydes. Hence, benefit agents containing high levels of aldehydes may be encapsulated with a lower propensity for adverse interactions between core-forming and shell-forming materials.

Other aminosilanes may also be used in combination with the aforementioned bipodal aminosilanes, in particular the aminosilanes described hereinabove.

The polyfunctional isocyanate may be selected from organic isocyanates, in which an isocyanate group is bonded to an organic residue (R—N═C═O or R—NCO). The polyfunctional isocyanate may be selected from alkyl, alicyclic, aromatic and alkylaromatic, as well as anionically modified polyfunctional isocyanates, with two or more (e.g. 3, 4, 5, etc.) isocyanate groups in a molecule, and mixtures thereof.

Preferably, the polyfunctional isocyanate is an aromatic or an alkylaromatic isocyanate, the alkylaromatic polyfunctional isocyanate having preferably methylisocyanate groups attached to an aromatic ring. Both aromatic and methylisocyanate-substituted aromatic polyfunctional isocyanates have a superior reactivity compared to alkyl and alicyclic polyfunctional isocyanates. Among these, 2-ethylpropane-1,2,3-triyl tris((3-(isocyanatomethyl)phenyl)carbamate) is particularly preferred, because of its trifunctional nature that favors the formation of intermolecular cross-links and because of its intermediate reactivity that favors network homogeneity. This alkylaromatic polyfunctional isocyanate is commercially available under the trademark Takenate D-100 N, sold by Mitsui or under the trademark Desmodur® Quix175, sold by Covestro.

As an alternative to aromatic or alkylaromatic polyfunctional isocyanates, it may also be advantageous to add an anionically modified polyfunctional isocyanates, because of the ability of such polyfunctional isocyanates to react at the oil/water interface and even in the water phase close to the oil/water interface. A particularly suitable anionically modified polyfunctional isocyanate has Formula (III).

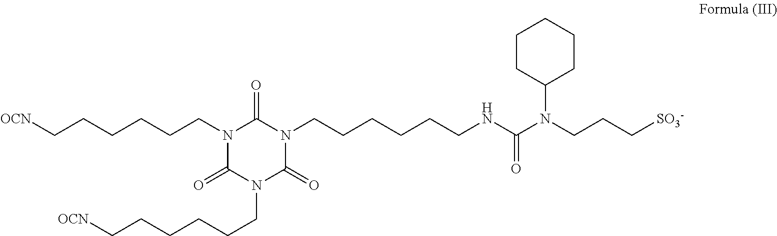

Formula (III) shows a commercially available anionically modified polyisocyanate, which is a modified isocyanurate of hexamethylene diisocyanate, sold by Covestro under the trademark Bayhydur® XP2547.

In a preferred embodiment of the present invention, polyfunctional isocyanate is 2-ethylpropane-1,2,3-triyl tris((3-(isocyanatomethyl)phenyl)carbamate). Particularly preferably, the polymeric stabilizer is formed by reaction of bis(3-(triethoxysilyl)propyl)amine and 2-ethylpropane-1,2,3-triyl tris((3-(isocyanatomethyl)phenyl)carbamate). The combination of this particular bipodal secondary aminosilane and polyfunctional isocyanate provides advantageous interface stability and release properties. The stabilized interface is sufficiently impervious to effectively encapsulate the at least one benefit agent comprised in the core and possesses the desired surface functional groups.

In preferred embodiments of the present invention the hydrated polymer phase can be a coacervate, in particular a complex coacervate.

By “complex coacervation” is meant the formation of an interfacial layer comprising a mixture of polyelectrolytes.

The phenomenon of coacervation may be observed under a light microscope, wherein it is marked by the appearance of a ring around the core composition droplet. This ring consists of the aforementioned polyelectrolyte-rich phase that has a different refractive index than the surrounding aqueous phase.

The coacervation of a polyelectrolyte is generally induced by bringing the polyelectrolyte to its isoelectric point, meaning the point where the net charge of the polyelectrolyte is zero or close to zero. This may be achieved by changing the salt concentration or the pH of the medium. In a complex coacervation, complexation occurs at the pH where one of the polyelectrolytes has an overall positive electrical charge (polycation), whereas the other polyelectrolyte has an overall negative charge (polyanion), so that the overall electrical charge of the complex is neutral.

In preferred embodiments of the present invention, the coacervate may be formed from a polycation and a polyanion.

Preferably, the pH is used as parameter driving the coacervation. Thus, the polycation preferably has a pH-dependent electrical charge. This is the case for polymers bearing primary, secondary and tertiary amino groups, such as polyamines, for example chitosan, and most proteins, for example gelatin. Proteins have the additional advantage of being prone to temperature-dependent structural transitions that may also be used to control the morphology of the coacervates. In particular, varying the temperature of some proteins may induce the formation of secondary, tertiary or quaternary structures of the protein that may also be used to control the properties of the coacervate.

Chitosan has the advantage of being derived from chitin, which is a natural polymer.

In preferred embodiments of the present invention, the polycation is selected from the group consisting of proteins, chitosan, and combinations thereof.

More particularly, the polycation can be a protein selected from the group consisting of gelatin, casein, albumin, polylysine, soy proteins, pea proteins, rice proteins, hemp proteins, and combinations thereof.

In particularly preferred embodiments of the present invention, the at least one protein is a gelatin, even more preferably a Type B gelatin.

Type B gelatin can be obtained from the alkaline treatment of collagen and is well known for its ability to form complexes with anionic polyelectrolytes, such as negatively charged polysaccharides under mild acidic conditions.

Gelatin is usually characterized by the so-called “Bloom Strength”. In the context of the present invention, the Bloom Strength refers to the rigidity of a gelatin film, as measured by so-called “Bloom Gelometer”, according to the Official Procedures of the Gelatin Manufacturers Institute of America, Inc., revised 2019, Chapter 2.1. According to this procedure, the Bloom Strength, expressed in Bloom, is equal to the weight, expressed in g, required to move vertically a standardized plunger, having a diameter of 12.5 mm, to a depth of 4 mm into a gelatin gel, which has been prepared under controlled conditions, i.e. by dissolving 6.67 wt.-% of gelatin in deionized water at 60° C., in a standardized jar, and letting the gel form for 17 hours at 10° C. The higher the weight is, the higher is the Bloom Strength of the gelatin used for making the tested gel.

In preferred embodiments of the present invention, the Type B gelatin has a Bloom Strength of 90 to 250 Bloom.

If the Bloom Strength is too low, the gel is mechanically weak and coacervates obtained therefrom may not form a self-standing layer of gelatin-rich phase around the core composition.

If the Bloom Strength is too high, then the coacervates and the gelatin-rich phase obtained therefrom may be too brittle.

In preferred embodiments of the present invention, the Type B gelatin is obtainable from fish, because fish gelatin meets better acceptance within consumer than beef or pork gelatin, mainly due to health concerns, sociological context or religious rules.

Alternatively, the protein may be a vegetable protein, in particular a pea protein and/or a soy protein, which have the advantage of being vegan.

The polycation may be a denaturated protein. In the contrary to native proteins, denaturated proteins have been deprived from their ability to form secondary, tertiary or quaternary structures and are essentially amorphous. Such amorphous proteins may form more impervious films compared to native proteins and therefore also contribute to the encapsulating power of the shell. Denaturation may be achieved by treating the protein with chemical or physical means, such as acid or alkaline treatment, heat or exposure to hydrogen bond disrupting agents.

In cases where the polycation is chitosan, the chitosan can have a molecular weight between 3′000 and 1′000′000 g/mol, more particularly between 10′000 and 500′000 g/mol, still more particularly between 30′000 and 300′000 g/mol.

The polyanion may be any negatively charged polymer. However, as the pH is preferably used to control coacervation, it may be more advantageous that the electrical charge of the polymer is pH-dependent. Such polymer may be selected from polymers having pendent carboxylic groups, such as methacrylic acid and acrylic acid polymers and copolymers, hydrolyzed maleic anhydride copolymers and polysaccharides bearing carboxylic groups.

In preferred embodiments of the present invention, the polyanion is a polysaccharide comprising carboxylate groups and/or sulfate groups.

Polysaccharides comprising carboxylate groups are particularly suitable for complex coacervation with proteins. This is due to the fact that the net electrical charge of these polysaccharides may be adjusted by adjusting the pH, so that the complexation with ampholytic proteins is facilitated. Complexation occurs at the pH where the protein has an overall positive electrical charge, whereas the polysaccharide as an overall negative charge, so that the overall electrical charge of the complex is neutral. These polysaccharides include native polysaccharides, i.e. unmodified from nature, and modified polysaccharides.

The polysaccharide comprising carboxylic acid groups may comprise uronic acid units, in particular hexuronic acid units. Such polysaccharides are broadly available in nature.

The hexuronic acid units can be selected from the group consisting of galacturonic acid units, glucuronic acid units, in particular 4-O-methyl-glucuronic acid units, guluronic acid units, mannuronic acid units, and combinations thereof.

The polysaccharide comprising carboxylic acid groups may be branched. Branched polysaccharides comprising carboxylic acid groups have the advantage of forming more compact networks than linear polysaccharides and therefore may favor the imperviousness of the encapsulating shell, resulting in reduced leakage and greater encapsulation efficiency.

The carboxylate groups can be at least partially present in the form of the corresponding carboxylate salt, in particular the corresponding sodium, potassium, magnesium or calcium carboxylate salt.

In particular embodiments of the present invention, the polyanion is selected from the group consisting of pectin, gum arabic, alginate, and combinations thereof.

Among the pectins, the carboxylic acid groups can be partially present in the form of the corresponding methyl ester. The percentage of carboxylic acid groups that are present in the form of the corresponding methyl ester can be from 3% to 95%, preferably from 4% to 75%, more preferably from 5 to 50%. Pectins comprising carboxylic groups, of which 50% or more are present in the form of the corresponding methyl ester, are referred to as “high methoxylated”. Pectins comprising carboxylic acid groups, of which less than 50% are present in the form of the corresponding methyl ester, are referred to as “low methoxylated”.

Among the two variants of gum Arabic, i.e. gum acacia Senegal and gum acacia Seyal, gum acacia Senegal is preferred, owing to the higher level of glucuronic acid in gum acacia Senegal.

The hydrated polymer phase can be a hydrogel.

In context of the present invention, a “hydrogel” is a three-dimensional (3D) network of hydrophilic polymers that can swell in water, while maintaining the structure due to chemical or physical cross-linking of individual polymer chains.

Such a hydrogel can be formed by several methods at interfaces, especially by self-assembly of polyelectrolytes around existing interfaces, covalent grafting of pre-formed hydrogel particles in solution, polymerization of hydrosoluble monomers initiated at the interface and phase separation of water soluble macromolecules onto the interface.

To avoid any ambiguity, in context of the present invention, a coacervate, especially a complex coacervate, which is cross-liked, in particular by covalent bonds, is considered as a hydrogel.

The applicant has found that the use of hydrogels particularly enhances both the deposition and adherence of microcapsules on substrates, in particular on fabrics.

The hydrogel can be interlinked with the polymeric stabilizer, in particular via the functional groups present on the surface of this stabilizer.

This allows the locking of the hydrogel layer onto the polymeric stabilizer present at droplet interface, making the shell composed of a polymer composite, instead of only a blend.

Both hydrogel cross-linking and hydrogel interlinking with the polymeric stabilizer may be performed sequentially or simultaneously.

In preferred embodiments of the present invention, the hydrogel is a crosslinked coacervate, in particular a complex coacervate crosslinked with polyfunctional aldehyde, more particularly a difunctional aldehyde selected from the group consisting of succinaldehyde, glutaraldehyde, glyoxal, benzene-1,2-dialdehyde, benzene-1,3-dialdehyde, benzene-1,4-dialdehyde, piperazine-N,N-dialdehyde, 2,2′-bipyridyl-5,5′-dialdehyde, and combinations thereof.

Difunctional aldehydes are known to be effective cross-linking agents for proteins.

The hydrogel can be thermosensitive and possess a gelation temperature, in particular between 20° C. and 50° C., preferably between 25° C. and 40° C. When using such a hydrogel, the deposition performance of the capsules on fabric can increase, when washing the fabric at a temperature which is above hydrogel gelation temperature.

The shell can be further stabilized with a stabilizing agent. Preferably the stabilizing agent comprises at least two carboxylic acid groups. Even more preferably, the stabilizing agent is selected from the group consisting of citric acid, benzene-1,3,5-tricarboxylic acid, benzene-1,2,4-tricarboxylic acid, 2,5-furandicarboxylic acid, itaconic acid, poly(itaconic acid) and combinations thereof.

### Coacervates

In one embodiment, the shell can comprise a complex coacervate formed of at least one protein and at least one polysaccharide. Such core-shell capsules have proved suitable for benefit agent encapsulation and are described, for instance in WO 1996/020612 A1, WO 2001/03825 A1 or WO 2015/150370 A1.

Cross-linking of at least one protein with a first cross-linking agent followed by the addition of at least one polysaccharide to form a complex coacervate is described in WO 2021/239742 A1.

In one embodiment, the shell of the microcapsules can be made of a biodegradable material or a non-biodegradable material. In one embodiment, the microcapsules are made of a biodegradable material.

In preferred embodiments of the present invention, the volume median diameter Dv(50) of the plurality of core-shell microcapsules is from 1 to 100 μm, preferably 5 to 75 μm, more preferably 8 to 60 μm, even more preferably 10 to 30 μm. Microcapsules having volume median diameter in the range from 10 to 30 μm show optimal deposition on various substrates, such as fabrics and hair.

The resultant encapsulated composition, presented in the form of a slurry of microcapsules suspended in an aqueous suspending medium, may be incorporated as such in a perfume composition that is entrapped in a water-soluble matrix. If desired, however, the slurry may be dried to present the encapsulated composition in dry powder form. Drying of a slurry of microcapsules is conventional, and may be carried out according techniques known in the art, such as spray-drying, evaporation, lyophilization or use of a desiccant. Typically, as is conventional in the art, dried microcapsules will be dispersed or suspended in a suitable powder, such as powdered silica, which can act as a bulking agent or flow aid. Such suitable powder may be added to the encapsulated composition before, during or after the drying step.

Combining at least two encapsulation processes has the advantage of providing different mechanisms for releasing the functional material, for example a combination of moisture-induced and mechanical stress-induced releases.

### Solid Carrier

Diluting a perfume composition that is entrapped in a water-soluble matrix in a carrier material allows for providing formulations that are compliant with dust explosion regulations, as it is known that the explosion risk increases with the concentration of the perfume ingredients in the powder.

The solid carrier can be selected from the group consisting of urea, sodium chloride, sodium sulphate, sodium acetate, zeolite, sodium carbonate, sodium bicarbonate, clay, talc, calcium carbonate, magnesium sulfate, gypsum, calcium sulfate, magnesium oxide, zinc oxide, titanium dioxide, calcium chloride, potassium chloride, magnesium chloride, zinc chloride, saccharides, polyethylene glycol, polyvinylpyrrolidone, citric acid or any water soluble solid acid, fatty alcohols, fatty acids and mixtures thereof.

The proportion of the solid carrier in the granulated composition can be between about 50 wt.-% to about 95 wt.-%, preferably between about 60 wt.-% to about 70 wt.-%, such as about 66.7 wt.-% relative to the total weight of the granulated composition. Under such conditions, the granulated composition may be maintained below critical explosion values, in terms of explosivity class and minimal ignition energy value.

### Flowing Agent

As alternative or in addition a solid carrier, a granulated composition according to the present invention can also comprise a flowing agent. The flowing agent is selected from the group consisting of silicon dioxide, sodium salts, calcium salts and zeolites. Flowing agents limit the risk of powder agglomeration and clogging, and ease the transfer of the granulated composition from one vessel to another.

The granulated powders of the present invention have MIE values above 1000 mJ, thereby presenting low ignition risk.

### Methods

A further aspect of the present invention relates to a method for preparing a granulated composition as described herein above. The method comprises the steps of:
a) Preparing an emulsion of a perfume composition in a solution of a water-soluble matrix material in water;
b) Subjecting the emulsion to drying, in particular spray-drying or adsorption onto an absorbent, to obtain a composition in which the perfume composition is entrapped in a water-soluble matrix; and
c) Blending the composition with a solid carrier to obtain a granulated composition.

In the emulsion step a), the soluble polymers may be solubilized in water, followed by the addition of perfume composition and mixing, in order to obtain a good quality pre-emulsion (i.e. droplets of sizes between 10-50 μm). Using a two-stage high-pressure homogenizer, a stable emulsion may be prepared and stocked in a buffer tank for drying. After the high pressure homogenization, the droplet size may be between about 1 to 5 μm.

The drying step b) may be subdivided into three spray drying stages. The first stage, taking place in a primary drying chamber, may involve converting the atomized droplets into dried powder. The operation may aim to achieve a powder moisture content of less than 10% wt (typically around 5% wt). This is mainly in order to strike a balance between obtaining a non-sticky powder, which will not plug up the internal fluid bed (IFB), but without requiring excessive high-temperature air to further reduce the moisture content within the short drying time in the primary drying chamber. The primary chamber temperature may be between 140-180° C. and the primary chamber pressure may be between about −60 bar to −40 bar.

The IFB may be an extension of the bottom section of the spray drying chamber with the purpose of providing a longer residence time to remove the residual moisture content to about 2% wt. The longer residence time in the IFB may allow the use of lower-temperature drying air at this second stage of drying. The airflow rate and the temperature used in the IFB may be delicately balanced to ensure sufficient secondary drying but preventing excessive breakage of the agglomerates from the primary drying stage. The IFB temperature may be between 50-70° C. and the IFB pressure may be between about 40 bar to 60 bar.

Fines returned to the top section of the primary chamber are intended to induce forced agglomeration with the atomized droplet and partially solidified powder from the nozzles. This may control the final product size distribution and the agglomerated structure.

The third stage of drying may take place in the external fluidized bed (EFB). The operation of the external bed may be a combination of drying (at the top of the bed) and cooling (progressively towards the end of the bed). The temperature of the drying air entering the bed may be individually controlled.

After the EFB stage, the powder of may be collected and sieved before submitting it to step c), in which the powdered perfume composition entrapped in a water-soluble matrix is blended with a solid carrier in order to obtain a granulated composition with the required median particle size by volume (Dv(50)) between about 90 μm to about 190 μm.

It is believed that the most important contribution to achievement of the required particle size is the interplay between the emulsion formulation, the spray-drying nozzle characteristic and the IFB and EFB parameters.

The perfume composition, water-soluble matrix and solid carrier are as described herein.

The granulated compositions of the present invention may be used to perfume consumer products that are anhydrous or in which the water activity is lower than 0.25, preferably lower than 0.1. These products include laundry care powder detergents and solid single dose detergent, such as tablets, laundry care conditioner sheets, fabric refreshers, scent boosters, and home care compositions, such as powder hard surface cleaners, and heavy duty detergents, such as dish washing tablets.

### Consumer Product

The present invention also relates to a consumer product comprising a granulated composition as described herein above, preferably a fabric care product or a home care product. Preferably, the fabric care product is a laundry detergent, preferably a hand wash laundry detergent.

Biodegradation is of particular importance for the aforementioned categories of consumer products, as during and after their intended use, components of these products enter the environment via domestic waste water. Biodegradation is the main process of removal in waste water treatment plants, environmental waters and soils.

A consumer product can contain the compositions as described herein above, preferably at a level of 0.005 to 5 wt.-%, more preferably from 0.01 to 1 wt.-%, and still more preferably from 0.02 to 0.5 wt.-%, optionally between about 0.3 wt.-% to about 0.4 wt.-% of the consumer product.

The present invention is further illustrated by means of the following non-limiting examples:

### Example 1: Preparation of Perfume Compositions Entrapped in a Water-Soluble Matrix of Different Particle Sizes

A perfume composition entrapped in a water-soluble matrix according to the present invention can be prepared as follows:

Tap water (82 g) is weighted into a stainless steel beaker. Starch sodium octenyl succinate E1450 (40.0 g) and mannitol (10.0 g) are subsequently weighted into the same beaker. The resulting mixture is first manually stirred with a stainless steel rod and then homogenized with an IKA T25 Ultra-Turrax Homogenizer at 13,500 rpm to obtain a homogeneous solution. To this resulting mixture, perfume oil (50.0 g) is added. Using a two-stage high-pressure homogenizer, a stable emulsion is produced. The droplet size is controlled by dynamic light scattering to be between 1 and 5 μm.

The emulsion is subjected to a three stage spray drying process.

The emulsion and spray drying process parameters are as defined in Table 1:

| | | Production parameters | | | | | |
|---|---|---|---|---|---|---|---|
| | | Sample 1 | Sample 2 | Sample 3 | Sample 4 | Sample 5 | Sample 6 |
| Steps | Particle Parameters | 63 μm | 100 μm | 125 μm | 150 μm | 200 μm | 250 μm |
| Emulsion | Feed temperature (° C.) | 50 | 50 | 50 | 50 | 50 | 50 |
| | feed rate (kg/h) | 330 | 320 | 220 | 300 | 305 | 295 |
| | Homogenizer pressure 1 | 80 | 80 | 80 | 80 | 80 | 80 |
| | (bar) | | | | | | |
| | Homogenizer pressure 2 | 20 | 20 | 20 | 20 | 20 | 20 |
| | (bar) | | | | | | |
| MSD | Chamber pressure (bar) | −50 | −50 | −50 | −50 | −50 | −50 |
| | Main air flow (M³/h) | 5300 | 5000 | 4800 | 5000 | 5000 | 5000 |
| | Main air temperature (° C.) | 150 | 167 | 145 | 167 | 162 | 167 |
| | IFB Air flow (M³/h) | 450 | 450 | 450 | 700 | 700 | 700 |
| | IFB Air flow temperature | 50 | 50 | 50 | 70 | 70 | 70 |
| | (° C.) | | | | | | |
| | EFB Heating air flow (M³/h) | 450 | 450 | 450 | 700 | 700 | 700 |
| | EFB heating air | 50 | 50 | 50 | 70 | 70 | 70 |
| | temperature (° C.) | | | | | | |
| | EFB cooling air flow (M³/h) | 500 | 500 | 500 | 800 | 800 | 800 |
| | EFB cooling air | 35 | 35 | 35 | 35 | 35 | 35 |
| | temperature (° C.) | | | | | | |
| | EFB outlet pressure (Pa) | 0 | 0 | 0 | 0 | 0 | 0 |
| | Fine powder conveying air | 80 | 80 | 80 | 80 | 80 | 80 |
| | flow ((M³/h) | | | | | | |
| | Fine powder conveying air | 40 | 40 | 40 | 40 | 40 | 40 |
| | temperature (° C.) | | | | | | |
| Nozzle | Nozzle brand | spraying | spraying | spraying | Delavan | Delavan | Delavan |
| | | system | system | system | Spray | Spray | Spray |
| | | | | | nozzle | nozzle | nozzle |
| | Nozzle type and | 1.2 mm | 1.2 mm | 1.2 mm | 2.7 mm | 2.7 mm | 3.4 mm |
| | Characteristic | | | | | | |
| | Atomization Pressure (bar) | 140 | 91 | 55 | 41 | 27 | 18 |

The resulting spray dried powders were subsequently blended with anhydrous sodium sulfate in a weight ratio of spray dried powder to anhydrous sodium sulfate of 1 to 2 to provide granulated compositions of various particle sizes.

### Example 2: Preparation of Hand Wash Powder Laundry Detergent Comprising the Granulated Compositions from Example 1 and Olfactive Evaluation of the Resulting Detergent Samples During Various Stages of Laundry Hand Washing Cycle

The granulated compositions comprising spry-dried Samples 1 to 6 obtained from Example 1 were blended into a powder detergent base at the level of 0.3 wt % of the total weight of the detergent to obtain six powder detergent samples PD1-PD6 employing Samples 1-6 of perfume compositions entrapped in a water-soluble matrix of different particle sizes.

After a step of laundry segregation (e.g. into baby clothing, whites, lights, everyday clothes, darks) generally a laundry hand washing cycle involves the following steps:
a) Soaking, involving pouring a pre-measured amount of powder detergent into the washing water, soaking, wringing out and pulling the laundry out of the water;
b) Scrubbing;
c) Rinsing with water;
d) Optionally, repeat steps b) and c);
e) Hanging to dry.

The user may have an olfactive experience at every stage of the cycle.

Samples PD1-PD6 were evaluated by an expert olfactory panel in a hand wash protocol of cotton towels.

The hand wash protocol was as follows:
A hand washing bucket was filled with 1500 g of water
6 grams of hand wash detergent PD1 to PD6
2 cotton towels
Towels were subjected to the hand washing cycle described above
Each towel was evaluated above the washing container by 15-20 panelists
The towels were evaluated using the Intensity scale shown below

Intensity scale: 0—No Fragrance; 0.5—Very weak; 1—Weak; 1.5—Fairly weak; 2—Relatively weak; 2.5—Moderate; 3—Relatively strong; 3.5—Fairly strong; 4—Strong; 4.5—Very strong; 5—Extremely strong.

A score of 1.5 is the minimum threshold for consumer-relevant performance.

The results are presented in Table 2:

| | Spray-dried | | |
|---|---|---|---|
| Detergent sample | powder sample | Dv50 (μm) | Fragrance intensity |
| PD1 | Sample 1 | 63 | 2.5 |
| PD2 | Sample 2 | 100 | 3 |
| PD3 | Sample 3 | 125 | 4 |
| PD4 | Sample 4 | 150 | 3 |
| PD5 | Sample 5 | 200 | 2.5 |
| PD6 | Sample 6 | 250 | 2 |

It can be seen that the detergents employing powders of particle sizes below (PD1) and above (PD5 and PD6) a range of between about 90 μm to about 190 μm showed lower fragrance intensities than detergents employing powders according to the invention (PD2-PD4).

In another set of measurements, the granulated compositions comprising spray-dried Samples 1 to 3 obtained from Example 1 were blended into a powder detergent base at the level of 0.37 wt % of the total weight of the detergent to obtain three powder detergent samples PD′1-PD′3 employing Samples 1-3 of perfume compositions entrapped in a water-soluble matrix of different particle sizes. Samples PD′1 to PD′3 were evaluated by an expert olfactory panel in a hand wash protocol of cotton towels as described above, at various stages of the washing cycle, using the intensity scale as described above.

The results are shown in Table 3:

| | | | 10 min | | |
|---|---|---|---|---|---|
| Detergent | | | soaking and | | 30 min |
| sample | Dv50 (μm) | initial | scrubbing | rinsing | rescrubbing |
| PD′1 | 63 | 4 | 3 | 3 | 3 |
| PD′2 | 100 | 3 | 4 | 3.5 | 4 |
| PD′3 | 125 | 4 | 4 | 4 | 4 |

The overall evaluation shows that detergents employing powders according to the invention (PD′2 and PD′3) have sustained and higher performance than a detergents employing a powder of particle size below the range of between about 90 μm to about 190 μm (PD′1) throughout the washing cycle, and not only at the initial stage of dissolving the detergent powder into the water.

1. A granulated composition for powder detergent, the composition comprising
a) a perfume composition that is entrapped in a water-soluble matrix; and
b) a solid carrier,
wherein the median particle size by volume (Dv(50)) of the granulated composition is between about 90 μm to about 190 μm.

2. The granulated composition according to claim 1, wherein the water-soluble matrix comprises at least one material selected from the group consisting of starch, maltodextrin, mannitol, chitosan, gum Arabic, alginate, cellulose, pectins, gelatin, polyvinyl alcohol and mixtures thereof.

3. The granulated composition according to claim 12, wherein the water-soluble modified starch is selected from the group consisting of bleached starch, hydroxypropyl starch, hydroxypropyl distarch phosphate, dydroxypropyl distarch glycerol, acetylated distarch phosphate, starch acetate esterified with acetic anhydride, starch acetate esterified with vinyl acetate, acetylated distarch adipate, acetylated distarch glycerol, starch sodium octenyl succinate and mixtures thereof.

4. The granulated composition according to claim 1, wherein the water-soluble matrix additionally comprises a compound selected from the group consisting of maltodextrin, mannitol and mixtures thereof.

5. The granulated composition according to claim 1, wherein the water-soluble matrix additionally comprises a hemicellulose.

6. The granulated composition according to claim 1, wherein the perfume composition comprises at least one biodegradable ingredient(s).

7. The granulated composition according to claim 1, wherein the perfume composition is partially encapsulated in core-shell microcapsules comprising a core and a shell surrounding the core.

8. The granulated composition according to claim 1, wherein the solid carrier is selected from the group consisting of urea, sodium chloride, sodium sulphate, sodium acetate, zeolite, sodium carbonate, sodium bicarbonate, clay, talc, calcium carbonate, magnesium sulfate, gypsum, calcium sulfate, magnesium oxide, zinc oxide, titanium dioxide, calcium chloride, potassium chloride, magnesium chloride, zinc chloride, saccharides, polyethylene glycol, polyvinylpyrrolidone, citric acid or any water soluble solid acid, fatty alcohols, fatty acids and mixtures thereof.

9. A method for preparing a granulated composition according to claim 1, the method comprising the steps of:
a) Preparing an emulsion or a suspension of a perfume composition in a solution of a matrix material in water;
b) Subjecting the emulsion to drying or adsorption onto an absorbent, to obtain a composition in which the perfume composition is entrapped in a water-soluble matrix; and
c) Blending the composition with a solid carrier to obtain a granulated composition.

10. A method of utilizing a granulated composition according to claim 1, wherein the method comprises incorporating the granulated composition into a consumer product.

11. A consumer product comprising the granulated composition according to claim 1.

12. The granulated composition according to claim 2, wherein the starch comprises water-soluble modified starch.
